(19) United States
(12) Patent Application Publication
(10) Pub. No.: US 2021/0186302 A1
(43) Pub. Date: Jun. 24, 2021

(54) LIQUID DRAINAGE DEVICE

(71) Applicant: Regino Aparri, Indianapolis, IN (US)

(72) Inventor: Regino Aparri, Indianapolis, IN (US)

(21) Appl. No.: 16/719,810

(22) Filed: Dec. 18, 2019

(51) Int. Cl. A47L 19/02; A47J 47/20

(52) U.S. Cl. CPC A47L 19/02; A47J 47/20

(57) ABSTRACT

A liquid drainage device, including a main body, including a main surface disposed on a top surface of the main body to receive at least one item thereupon, an elevated side disposed on at least a portion of a first end of the main body, and a tapered side disposed on at least a portion of a second end of the main body, such that the main surface directs a liquid from the elevated side toward the tapered side in response to the liquid contacting at least a portion of the main surface, a plurality of protruding members disposed on at least a portion of the main surface to prevent movement of the at least one item, and a liquid receiving groove longitudinally disposed along a center of the main surface to direct the liquid away from the main surface.

### BACKGROUND

### 1. Field

The present general inventive concept relates generally to a device, and particularly, to a liquid drainage device.

### 2. Description of the Related Art

In many kitchens, dishes are washed in a sink and then left to dry. However, water left on the dishes usually drips on a countertop, leaving water stains and a likely causing water damage.

Unfortunately, most countertops are flat. As a result, water on the countertop does not have a specific drainage destination. Moreover, a conventional dish rack keeps water wherever it is placed, even on a floor. In these circumstances, a person who enters a kitchen is at risk of falling from stray patches of water on the floor.

Therefore, there is a need for a water drainage device to direct water toward a specific destination.

### SUMMARY

The present general inventive concept provides a liquid drainage device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a liquid drainage device, including a main body, including a main surface disposed on a top surface of the main body to receive at least one item thereupon, an elevated side disposed on at least a portion of a first end of the main body, and a tapered side disposed on at least a portion of a second end of the main body, such that the main surface directs a liquid from the elevated side toward the tapered side in response to the liquid contacting at least a portion of the main surface, a plurality of protruding members disposed on at least a portion of the main surface to prevent movement of the at least one item, and a liquid receiving groove longitudinally disposed along a center of the main surface to direct the liquid away from the main surface.

The main surface may include a first section, and a second section disposed on at least a portion of the first section.

The first section and the second section may slope toward the liquid receiving groove, such that the first section and the second section direct the liquid to flow toward the liquid receiving groove in response to contacting at least a portion of the main surface.

The liquid receiving groove may be recessed with respect to the main surface.

The liquid drainage device may further include a plurality of walls perpendicularly disposed on each edge of the main surface to prevent the liquid from flowing off the main surface.

The plurality of walls may be elevated with respect to the main surface.

The plurality of walls may include an exit groove disposed at a center of another at least one of the plurality of walls disposed on the tapered side to allow the liquid to flow out therefrom.

The liquid drainage device may further include an air dispensing aperture disposed between the main surface and the plurality of walls, and an air generator disposed within at least a portion of the main body to generate air to move through the air dispensing aperture, such that the air dispensing aperture directs the air onto the main surface to move the liquid toward the liquid receiving groove.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a liquid drainage device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

| | |
|---|---|
| Liquid Drainage Device | 100 |
| Main Body | 110 |
| Main Surface | 111 |
| First Section | 111a |
| Second Section | 111b |
| Base | 112 |
| Elevated Side | 113 |
| Tapered Side | 114 |
| First Flanking Side | 115 |
| Second Flanking Side | 116 |
| Protruding Members | 120 |
| Liquid Receiving Groove | 130 |
| Walls | 140 |
| Exit Groove | 141 |
| Air Dispensing Aperture | 150 |
| Air Generator | 160 |
| Power Button | 170 |
| Power Source | 180 |

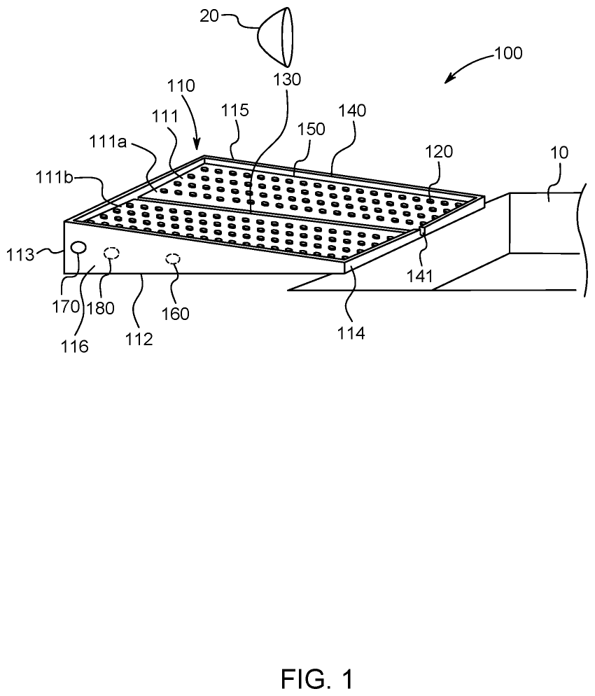

FIG. 1 illustrates a side perspective view of a water drainage device 100, according to an exemplary embodiment of the present general inventive concept.

The liquid drainage device 100 may be constructed from at least one of metal, plastic, wood, ceramic, glass, and rubber, etc., but is not limited thereto.

The liquid drainage device 100 may include a main body 110, a plurality of protruding members 120, a liquid receiving groove 130, a plurality of walls 140, an air dispensing aperture 150, an air generator 160, a power button 170, and a power source 180, but is not limited thereto.

The main body 110 may have a predetermined size. For example, the main body 110 may have a length of forty-four inches and a width of eight and a half inches.

The main body 110 may include a main surface 111, a base 112, an elevated side 113, a tapered side 114, a first flanking side 115, and a second flanking side 116, but is not limited thereto.

The main surface 111 may include a first section 111a and a second section 111b, but is not limited thereto.

Referring to FIG. 1, the first section 111a and the second section 111b are illustrated to each comprise half of the main surface 111. However, a size of the first section 111a may be greater than a size of the second section 111b. Alternatively, the size of the first section 111a may be less than the size of the second section 111b. Also, the second section 111b may be disposed on at least a portion of the first section 111a.

The main surface 111 may be disposed on a top surface of the main body 110. The main surface 111 may receive at least one item 20 thereupon, such as a kitchen utensil and/or a dishware. Additionally, the main surface 111 may be a smooth surface to facilitate movement of a liquid in contact thereof.

The base 112 may be disposed on a bottom surface of the main body 110, opposite with respect to the main surface 111. The base 112 may be disposed upon a planar surface, such as a table and/or a countertop. As a result, the base 112 may support the main body 110 on the planar surface.

The elevated side 113 may be disposed at a first end of the main body 110 and perpendicularly disposed away from a first end of the base 112 with respect to a first direction. Similarly, the tapered side 114 may be disposed at a second end of the main body 110 and perpendicularly disposed away from a second end of the base 112 with respect to the first direction. In other words, the elevated side 113 may be in parallel with the tapered side 114.

However, a height of the elevated side 113 may be greater than a height of the tapered side 114, such that the main surface 111 may direct the liquid to flow from the elevated side 113 toward the tapered side 114 in response to contacting at least a portion of the main surface 111. For example, the height of the elevated side 113 may be one inch. As such, the main surface 111 may be sloped at a predetermined angle with respect to the base 112 from the elevated side 113 toward the tapered side 114.

The first flanking side 115 may be perpendicularly disposed away from a first end of the elevated side 113 with respect to a second direction. Similarly, the second flanking side 116 may be perpendicularly disposed away from a second end of the elevated side 113 with respect to the second direction, such that the first flanking side 115 and the second flanking side 116 connect to a first end and a second end, respectively, of the tapered side 114. In other words, the first flanking side 115 may be in parallel with the second flanking side 116. Furthermore, the first flanking side 115 and the second flanking side 116 may be sloped in the same manner as the main surface 111 with respect to the base 112.

The plurality of protruding members 120 may be disposed on at least a portion of the main surface 111. More specifically, the plurality of protruding members 120 may be disposed on at least a portion of the first section 111a and at least a portion of the second section 112 to extend a distance away from the first section 111a and the second section 111b with respect to a third direction. The plurality of protruding members 120 may prevent movement of the at least one item 20 along the main surface 111.

The liquid receiving groove 130 may be longitudinally disposed along a center of the main surface 111. Moreover, the liquid receiving groove 130 may be recessed with respect to the main surface 111. For example, the liquid receiving groove 130 may be half an inch deep and two inches wide.

Furthermore, a height of a first side of the first section 111a corresponding to the first flanking side 115 may be greater than a height of a second side of the first section 111a corresponding to the liquid receiving groove 130. Similarly, a height of a first side of the second section 111b corresponding to the second flanking side 116 may be greater than a height of a second side of the second section 111b corresponding to the liquid receiving groove 130. In other words, the first section 111a and the second section 111b may slope toward the liquid receiving groove 130, such that the first section 111a and the second section 111b may direct the liquid to flow from the first flanking side 115 and/or the second flanking side 116 toward the liquid receiving groove 130 in response to contacting at least a portion of the main surface 111.

The plurality of walls 140 may include an exit groove 141, but is not limited thereto.

The plurality of walls 140 may be perpendicularly disposed on each edge of the main surface 111 to extend another distance away from the main surface 111 with respect to the first direction and/or the third direction. More specifically, at least one of the plurality of walls 140 on the elevated side 113 and/or the tapered side 114 may extend the another distance away from the main surface 111 with respect to the first direction, and another at least one of the plurality of walls 140 disposed on the first flanking side 115 and/or the second flanking side 116 may extend the another distance away from the main surface 111 with respect to the third direction.

As such, the plurality of walls 140 may be elevated with respect to the main surface 111. The plurality of walls 140 may prevent the liquid from flowing off the main surface 111.

Referring again to FIG. 1, the exit groove 141 may be disposed at a center of the at least one of the plurality of walls 140 disposed on the tapered side 114. The exit groove 141 may be connected to an end of the liquid receiving groove 130.

Alternatively, another exit groove 141 (not illustrated) may be disposed at a center of the at least one of the plurality of walls 140 disposed on the elevated side 113. As such, the another exit groove 141 may be connected to another end of the liquid receiving groove 130.

The exit groove 141 may allow the liquid to flow out therefrom. Moreover, the main surface 111 may direct the liquid into the liquid receiving groove 130, such that the liquid receiving groove 130 may direct the liquid away from the main surface 111 to the exit groove 141, such that the liquid may exit into a sink 10.

The air dispensing aperture 150 may be disposed between the main surface 111 and the at least one of the plurality of walls 140.

The air generator 160 may include a motor and a fan, but is not limited thereto.

The air generator 160 may be disposed within at least a portion of the main body 110. The air generator 160 may generate air to blow air from the air dispensing aperture 150. The air dispensing aperture 150 may direct the air onto the main surface 111 to facilitate drying and/or to direct the liquid toward the liquid receiving groove 130.

The power button 170 may include a button, a lever, a switch, a knob, and a dial, but is not limited thereto.

The power button 170 may be depressed to turn on and/or turn off the air generator 160. The air generator 160 may generate air in response to depressing the power button 170 a first time. The air generator 160 may stop generating the air in response to depressing the power button 170 a second time.

Additionally, the power button 170 may be depressed a first predetermined number of times and/or for a first predetermined duration of time to increase a speed of the air from the air generator 160. Alternatively, the power button 170 may be depressed a second predetermined number of times and/or a second predetermined duration of time to decrease the speed of the air from the air generator 160.

The power source 180 may include a power cord, a battery, a solar cell, but is not limited thereto. Additionally, the battery may include lithium-ion, nickel cadmium, nickel metal hydride, alkaline, etc., but is not limited thereto.

The power source 180 may send power to at least one of the air generator 160 and the power button 170.

Therefore, the water drainage device 100 may direct the liquid toward a specific drainage destination, such as the sink 10. As such, the water drainage device 100 may prevent stains and damage from liquid on a surrounding surface.

The present general inventive concept may include a liquid drainage device 100, including a main body 110, including a main surface 111 disposed on a top surface of the main body 110 to receive at least one item 20 thereupon, an elevated side 113 disposed on at least a portion of a first end of the main body 110, and a tapered side 114 disposed on at least a portion of a second end of the main body 110, such that the main surface 111 directs a liquid from the elevated side 113 toward the tapered side 114 in response to the liquid contacting at least a portion of the main surface 111, a plurality of protruding members 120 disposed on at least a portion of the main surface 111 to prevent movement of the at least one item 20, and a liquid receiving groove 130 longitudinally disposed along a center of the main surface 111 to direct the liquid away from the main surface 111.

The main surface 111 may include a first section 111a, and a second section 111b disposed on at least a portion of the first section 111a.

The first section 111a and the second section 111b may slope toward the liquid receiving groove 130, such that the first section 11a and the second section 111b direct the liquid to flow toward the liquid receiving groove 130 in response to contacting at least a portion of the main surface 111.

The liquid receiving groove 130 may be recessed with respect to the main surface 111.

The liquid drainage device 100 may further include a plurality of walls 140 perpendicularly disposed on each edge of the main surface 111 to prevent the liquid from flowing off the main surface 111.

The plurality of walls 140 may be elevated with respect to the main surface 111.

The plurality of walls 140 may include an exit groove 141 disposed at a center of another at least one of the plurality of walls 140 disposed on the tapered side 114 to allow the liquid to flow out therefrom.

The liquid drainage device 100 may further include an air dispensing aperture 150 disposed between the main surface 111 and the plurality of walls 140, and an air generator 160 disposed within at least a portion of the main body 110 to generate air to move through the air dispensing aperture 150, such that the air dispensing aperture 150 directs the air onto the main surface 111 to move the liquid toward the liquid receiving groove 130.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A liquid drainage device, comprising:
a main body, comprising:
a main surface disposed on a top surface of the main body to receive at least one item thereupon,
an elevated side disposed on at least a portion of a first end of the main body, and
a tapered side disposed on at least a portion of a second end of the main body, such that the main surface directs a liquid from the elevated side toward the tapered side in response to the liquid contacting at least a portion of the main surface;
a plurality of protruding members disposed on at least a portion of the main surface to prevent movement of the at least one item;
a liquid receiving groove longitudinally disposed along a center of the main surface to direct the liquid away from the main surface;
a plurality of walls perpendicularly disposed on each edge of the main surface to prevent the liquid from flowing off the main surface;
an air dispensing aperture disposed between each edge of the main surface and the plurality of walls to form a perimeter along each edge of the main surface and is entirely contiguous around the perimeter along each edge of the main surface; and
an air generator disposed within at least a portion of the main body to generate air to move through the air dispensing aperture, such that the air dispensing aperture directs the air onto the main surface to move the liquid toward the liquid receiving groove.

2. The liquid drainage device of claim 1, wherein the main surface comprises:
a first section disposed on a first side of the liquid receiving groove; and
a second section disposed on a second side of the liquid receiving groove.

3. The liquid drainage device of claim 2, wherein the first section and the second section slope toward the liquid receiving groove, such that the first section and the second section direct the liquid to flow toward the liquid receiving groove in response to contacting at least a portion of the main surface.

4. The liquid drainage device of claim 1, wherein the liquid receiving groove is recessed with respect to the main surface.

5. (canceled)

6. The liquid drainage device of claim 1, wherein the plurality of walls are elevated with respect to the main surface.

7. The liquid drainage device of claim 1, wherein the plurality of walls comprises:
an exit groove disposed at a center of at least one of the plurality of walls disposed on the tapered side to allow the liquid to flow out therefrom.

8. (canceled)

9. (canceled)
